(19) United States
(12) Patent Application Publication
(10) Pub. No.: US 2022/0060788 A1
(43) Pub. Date: Feb. 24, 2022

(54) Systems and Methods for Capturing and Distributing Specified Moments of Activity

(71) Applicants: Douglas C. Harling, Lenexa, KS (US); Kyle A. Haulette, Lee's Summitt, MO (US); Carl A. Moeller, III, Lenexa, KS (US)

(72) Inventors: Douglas C. Harling, Lenexa, KS (US); Kyle A. Haulette, Lee's Summitt, MO (US); Carl A. Moeller, III, Lenexa, KS (US)

(21) Appl. No.: 16/997,026

(22) Filed: Aug. 19, 2020

(51) Int. Cl. H04N 21/45; H04N 21/44; H04W 4/14

(52) U.S. Cl. CPC H04N 21/4524; H04W 4/14; H04N 21/44

(57) ABSTRACT

The present invention relates to systems and methods of providing video highlights of memorable moments of an activity or event to an end-user that are triggered by a request from the end-user shortly after the moments occur.

### BACKGROUND OF THE INVENTION

### A. Field of the Invention

The present invention relates to capturing and distributing recorded moments of activity. More specifically, the invention provides systems and methods for capturing and distributing images of specific moments that are initiated by an end-user. The invention provides systems and methods for viewing newly captured images and reviewing previously stored image content with an electronic device.

### B. Description of the Related Art

Parents, coaches, and fans not only want to watch an event as it unfolds, but also preserve memorable moments of the event to re-watch and share with others. But, if they personally record the event with a hand-held video camera, camera, or analogous device, e.g. a mobile phone, then they usually are forced to view the event through a single lens rather than with their own eyes. This narrowed viewing of the event can lead to someone missing out on the entirety of the event and the associated camaraderie. Further, it often seems like the memorable part of the event that they want to keep is the very part that they missed because the camera was off, ran out of battery power, or because of a distraction at or away from the event (e.g. a child in need, scorekeeping of the event, crowd activity, etc.).

Today, many sports facilities are able to live stream events. This service has two negative aspects: live streaming takes up a large amount of internet bandwidth; and it requires that all users who want to see the event be available when the event is happening in real-time.

### SUMMARY OF THE INVENTION

The present invention relates to systems and methods of distributing recorded highlights of one or more moments of interest (or moments) of an activity that are triggered by a request(s) from an end-user (user) shortly after the moment(s) occurs. For example, an end-user watches or participates in an activity and sees a moment of interest within the activity occur. The end-user performs an action, such as texting a code, pressing a button, using a computing application on a mobile phone (i.e. an app), sending an email, or otherwise sending an instruction that directs a system of the invention to create a short recording (e.g. a video or highlight) encompassing the moment and to send the short recording to the end-user or saves the short recording for later viewing and sharing.

Advantageously, the invention uses little internet bandwidth relative to comparable systems and methods that are used for live streaming.

The invention relates to video photography and, particularly, to a system for segmenting video recordings such that a user can grab the recorded footage from an event that occurred within the previous seconds or minutes. The invention allows users to save desirable portions of an event as it happens. Advantageously, a user does not need to obtain a recording of the entire event or edit such a recording afterwards in order to identify and obtain the desired portions that constitute moments of interest (i.e. highlights).

The present invention provides systems and methods for creating and distributing highlights of moments of an activity that are triggered by a user after the moments occur.

Advantageously, the invention's functionality provides value to end-users, facilities, and sponsors. For end-users, the invention makes it easier to save highlights or moments of events for later viewing and sharing. With end-users no longer having to think about having their cameras in their hands, obstructing the views of others, or worrying that their enjoyment or experience of the event is being diminished by observing the activity through a camera lens, they have a far better chance of saving those great moments while still enjoying or experiencing the event.

Another advantage of the present invention is that if someone wants to create a highlight reel of great events, then this invention makes it easy to do. For example, someone can send a text or code to a specified phone number or other identifier for each desired moment and then later go to a website to view all of their requested highlights from the events. Later, a user can share these saved highlights with others who may not have been in attendance at the event.

The present invention allows end-users, who would like to capture a moment in time with their family or group at a special location such as a monument, tourist attraction or other locale, to capture those moments without having to request assistance from a third-party.

Facilities can achieve a competitive advantage over others by offering features of the invention at events held at their locations.

Advantageously, the invention provides systems and methods for event sponsors to embed advertising in highlights of an event. Because the highlights are created at the request of interested users, it is likely that such advertising will be viewed by audiences that are targeted particularly by an event's sponsors.

More specifically, the present invention provides a capture and distribution system having (a) an input video stream from a device that has a view of an area of interest, wherein the device produces a video stream of an event occurring in the area of interest; (b) a replay management system (RMS) that receives (or captures) and temporarily stores the video stream in multiple segments; and (c) a central video broker (CVB) through which a publish-moment-request is sent by a user to the replay management system for a specified moment of the event. Once the publish-moment-request is received by the replay management system, the replay management system captures a specific segment (first segment) of the video stream and one or more preceding segments (second segments) of the video stream; combines the specific segment (the first segment) and one or more preceding segments (second segments) to create a highlight that is sent to the central video broker; and the central video broker sends a notification to the user, or an interested third-party, according to the system configurations that the specified moment is available for viewing.

A publish-moment-request may be sent by a user through a variety of means. For example, a user may use a short message service (SMS), a button on a device, a mobile telephone application (an app), an email, or any other suitable means that is compatible with systems of the invention.

Similarly, moment notifications, as well as, other notifications may be sent from the central video broker to the user, or an interested third-party, according to the system configurations by using the same means used by the user or an alternate means. For example, a moment notification may be sent to a user by an SMS text service, by email or through a mobile telephone application (an app).

In preferred systems of the invention, the replay management system temporarily saves the moment in a directory monitored by the directory monitor program prior to sending the moment (highlight) to the central video broker. The moment may be a highlight video.

Preferably, the central video broker permanently saves the moments (highlights) created with the replay management system.

Preferred systems of the invention include two or more devices with a view of an area of interest that are sources of video feeds. Sources of video feeds may or may not be in fixed or stationary positions. Herein, those of skill in the art will recognize that a variety of devices may function as sources of video feeds in the context of the invention. It is only necessary that a device is able to record and transmit a video feed that can be received by a system of the invention. Herein, for ease of discussion the term “camera” is used throughout and the term “camera” means both cameras and other devices that are sources of video feeds suitable for use in the invention. In certain preferred embodiments, more than one device is present.

In certain embodiments, the central video broker adds one or more logos, symbols, animations, statements, or combinations thereof to the highlight (moment) and saves the modified moment prior to sending the moment availability notification.

Embodiments of the invention can include a central video broker that creates one or more still pictures from the moment, permanently saves the still pictures, and sends a pictures notification to the user that the still pictures are available for viewing.

Systems of the invention can include a central video broker that augments a moment with text, still photos, video, statements, audio, or a combination thereof; permanently saves the augmented moment; and sends an augmented moment notification to the user that the augmented moment is available for viewing.

Embodiments of systems of the invention arrange segments of the video stream chronologically to create a highlight or moment. A moment or highlight comprises at least two segments of video in chronological order. Preferred embodiments provide highlights or moments that comprise three or more segments of a video stream. More preferably, a moment or highlight comprises 3 to 60 segments arranged chronologically.

In certain preferred embodiments, a segment comprises 1 to 60 seconds of a video stream, and more preferably a segment comprises 5 to 15 seconds. In these embodiments, a highlight may be as short as 2 seconds, as long as 60 minutes, or any amount of time between 2 seconds and 60 minutes. More preferably, moments or highlights are 1 to 15 minutes in length, and most preferably, highlights or moments are about 2 to 5 minutes in length.

The invention also provides methods of creating and distributing a moment comprising (a) situating at least one device to have a view of an area of interest; (b) producing a video stream of an event occurring in the area of interest with the device; (c) sending the video stream from the device to a replay management system; (d) receiving and temporarily storing the input video stream in multiple chronological segments in the replay management system; (e) sending a publish-moment-request for a specified moment of the event from a user through a central video broker to the replay management system; (f) capturing a specific segment (first segment) and one or more preceding segments (second segments) of the temporarily stored video stream, wherein the specific segment and one or more preceding segments encompass the specified moment; (g) combining the specified segment and one or more preceding segments (the first and second segments) to create a moment (or highlight); (h) sending the moment to the central video broker; and (i) sending a notification to the user, or an interested third-party, according to the system configurations that the requested moment is available for viewing.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein. Unless specifically noted, articles depicted in the drawings are not necessarily drawn to scale.

FIG. 1 outlines the operation of the system in an exemplary embodiment.

FIG. 2 is a flowchart outlining the technical operation of the system, which illustrates what the software does from start to finish.

FIG. 3 is a diagram showing the process by which a video feed is segmented and temporarily saved as a loop.

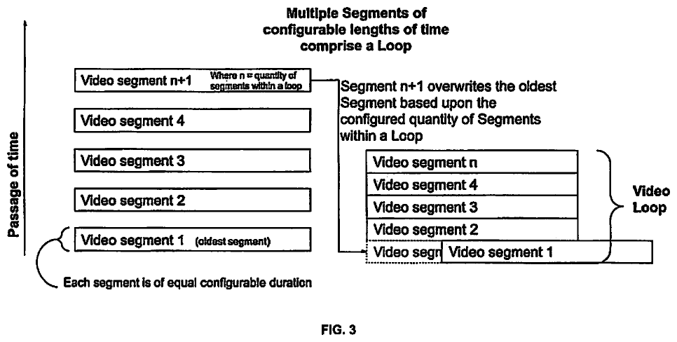

### DETAILED DESCRIPTION

The invention provides systems for capturing and creating highlight recordings of events, as well as, distributing the recordings to users that have requested the creation and the highlight recordings.

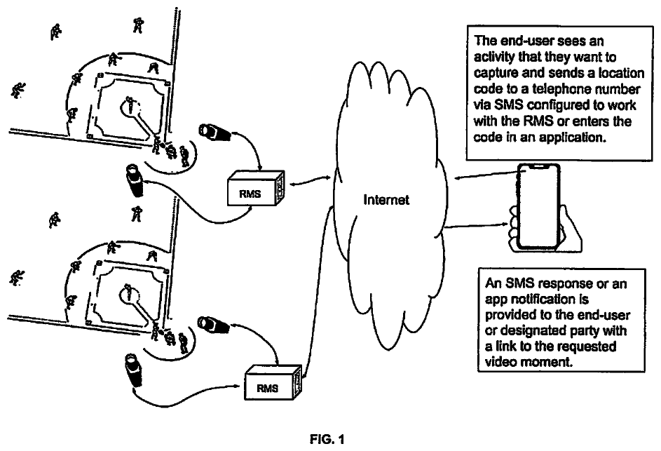

Systems of the invention comprise three primary parts: an input video stream, a replay management system, and a central video broker. Each of these primary parts also are composed of multiple parts. FIG. 1 illustrates an overview of how these parts interact with one another.

It should be appreciated that while FIG. 1 illustrates the use of the invention in conjunction with a baseball game, the invention is applicable to many different types of events. For example, the invention is applicable to any team or individual sport venue such as a basketball court, rodeo arena, skate/snowboard park, golf course, etc., as well as being, applicable to any tourist venue (e.g. a zoo, monument, tourist attraction) where individuals would like a hands-free technology to capture highlights of their visits. Those of skill in the art will appreciate that systems of the invention also can be applicable to user-directed civil monitoring of other types of areas of interest whereby citizens may want to capture other types of activities (e.g. accidents, natural disasters, or misdoings occurring within a public space) and send notifications of such moments to others.

An input video stream comprises one or more cameras or recording devices that are able to produce and transmit a video feed or series of images of an event that occurs at an area of interest (e.g. a playing field, theatre, sports or amusement venue, tourist attraction, street intersection, subway platform, etc.). If the cameras or recording devices are affixed in their locations, their perspective of the area of interest can be adjusted. For example, a camera may be fixed in place to view the same area at all times. Alternatively, a camera may pan from side-to-side or across the area. A camera may be programmed to only track the movement of objects or individuals in the area once such movement is detected, or a camera may be set to automatically pan.

Many suitable cameras and recording devices are known in the art. It is only necessary that the chosen devices are able to produce and transmit a series of high-quality images of an event to the replay management system. Suitable exemplary video streaming media include rtsp, rtmp, mpeg, or YouTube® channel protocols. Those of skill in the art will appreciate that other analogous protocols may be substituted without diverging from the scope of the present invention.

In the example illustrated in FIG. 1, two cameras are provided for each field of play, and each camera has a different perspective. Each set of cameras transmits a video feed to a replay management system that is instructed to receive input from a specific set of cameras. Such instructions prevent a replay management system from inadvertently capturing portions of multiple simultaneous events and mixing them together.

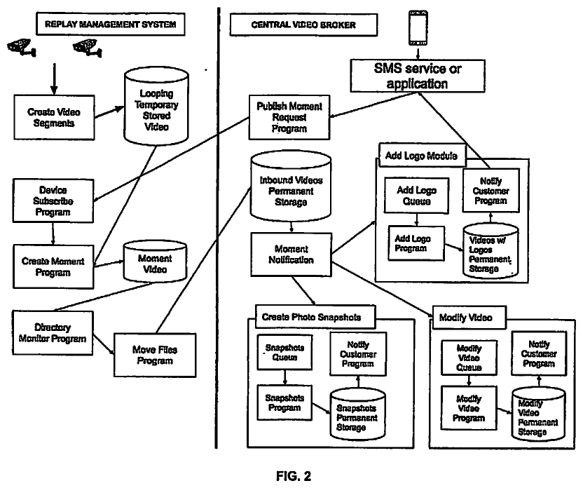

A replay management system (RMS) receives and segments the video feed that is transmitted from the cameras, devices (or other sources of video feed) for a particular event. An RMS may be on site or cloud based. See FIG. 2. The RMS converts the video feed into ffmpeg format and temporarily stores the converted video feed as individual mp4 files. Those of skill in the art will appreciate that other analogous formats may be substituted for ffmpeg or mp4 without diverging from the scope of the present invention. For example, h264, as well as, other Apple based formats may be used.

Rather than storing the converted video feed as a single contiguous recording, the RMS temporarily stores the converted video feed in predetermined portions or segments. A video feed can be divided into 1, 2, 3, 5, 10, 15, 20, or any suitable number of portions. The number of portions of video that are stored on the RMS is configurable and once the maximum number of portions or segments has been reached then the RMS “loops” the process and begins to replace the oldest segment with the most recently captured segment. An RMS is configured with the number of segments to be contained in the loop of video based upon the activity occurring at the area of interest.

A loop can be configured to comprise 1, 2, 3, 5, 10, 15, 20, 25, 30, 40, 50, 60, 70, 80, 90, 100, or any number of segments. The number of segments that comprise any one loop depends, at least in part, upon programming preferences, overall system limitations, and desired segment and loop lengths. For example, a loop that is 20 minutes in length may comprise 20 segments of 1 minute each; 40 segments of 30 seconds each; or 10 segments of 2 minutes each. Longer loop lengths, as well as, longer segment lengths may be preferred for events that unfold more slowly relative to other types of events. A preferred loop length that has been found to work well in the invention is a loop length of 15 minutes.

Segments are in chronological order. Preferred segment durations can be as short as 1 second or as long as 20 minutes. An especially preferred segment duration is 30 seconds. The number of segments that are created is a configurable number. A preferred configurable number of segments in a loop is 30.

Once the maximum number of segments for which a loop is configured is reached, the RMS modifies the loop by replacing the segment files with new video segment files from the incoming stream. The RMS always replaces the oldest segment file with the newly created segment file. In this way, for example, the first segment file (the oldest segment file contained within the loop) would be replaced every few minutes (or other predetermined amount of time) by new footage (the newest segment file) coming from the input stream. Each segment is distinct from any other segment; that is, no two segments include the same video footage or overlapping video footage.

For example, a segment duration is set for 30 seconds, and the number of segments is set to 10. The RMS is started at 1:00 PM. The first segment, segment_01, will capture 30 seconds of video then break. The first segment, segment_01, will contain video from 1:00:00 to 1:00:30. Once the configurable duration of the first segment is met, a new segment file, segment_02, is created. This segment captures 30 seconds of video then breaks. The second segment, segment_02, will contain video from 1:00:31 to 1:01:00. This pattern continues. When the configured number of segments for a loop is reached, the RMS will replace the oldest segment file, existing segment_01, with a new video segment file, new segment_01′. Next the RMS will replace existing segment_02 with newly created segment_02′ and so on until the configured number of segments for the loop is reached. The RMS continues to repeat the process until the event ends.

The RMS also “listens for” or receives capture-moment-requests. Capture-moment-requests are initiated (generated) by a user (end-user) and sent through the central video broker (CVB) to the RMS. Such requests can be generated through a variety of means. For example, a user may send a text from a short message service (SMS) message, press a physical button at an event site, or transmit a command from a computing program or application (e.g. a phone app) on a separate device. Capture-moment-requests may be sent by a user through any means that can transmit such requests through the CVB to the RMS.

As illustrated in FIG. 2, upon receipt of a publish-moment-request (a Publish Moment Request) by the Device Subscribe Program, the RMS uses its Create Moment Program to stitch together multiple video files that comprise a series of segments to create a moment that encompasses a requested highlight of the event and is a new mp4 file (a Moment Video). The new mp4 file is temporarily stored by the RMS in a directory monitored by the Directory Monitor Program.

The segments used to create the new mp4 file are in chronological order from a stored loop of segments. The number of segments, which form a loop, must be equal to or greater than the number of segments to be contained within a moment. Preferably, the number of segments in the loop exceeds the number of segments that are contained within a moment. By having the number of segments in a loop exceed the number of segments contained within a moment, the end-user has sufficient time after the activity for which they would like to obtain a replay to make a request for a moment. For example, if a configured moment length is one minute and each segment is 30 seconds, then the configured moment comprises two segments. If the loop is at least three segments, then the end-user has adequate time to submit a create-moment-request. Preferably, the number of segments that form a loop is ten times greater than the number of segments within a moment. Skilled artisans will appreciate that the number of segments that form a loop can range from one segment more than the number of segments that form a moment to twenty times to thirty times or more than the number of segments that form a moment. The number of segments that form a loop is dependent, at least in part, upon the length of a segment, the type of event, and personal preferences among other factors.

After the Moment Video is created, it is sent to the CVB using a Move Files Program in the RMS. The CVB permanently stores the inbound moment in its Inbound Videos Permanent Storage.

Because loop content is always overwriting itself in the memory of the RMS, a capture-moment-request must be sent relatively soon after the desired highlight occurs. Preferably, a capture-moment-request is sent no later than about 5 minutes after a moment of interest occurs. Most desirably, a capture-moment-request is sent within about 15 seconds after the moment of interest occurs. The shorter the period of time before the request is sent, then the greater the likelihood of capturing the entire moment, as well as, the relatively brief period of time leading to the highlight in the moment.

While the length of a moment can be almost unlimited, one of the advantages of the invention is that only the moments of interest of an event are captured. Generally, such highlights of an event are relatively short in comparison to the entire length of the event. Preferred lengths for a moment are about 15, 20, 30, 45, 50 seconds; or about 1, 1.25, 1.5, 1.75, 2, 3, 4, or 5 minutes. The selected length of a moment is, in part, dependent upon the type of highlight (e.g. sports play, visit to a tourist attraction or civil incident) and personal preferences. It will be understood that brief moments may be made available for little or no cost to an end-user and longer moments may be available to an end-user for a fee.

Software programming (the Directory Monitoring Program) watches the temporary directory for new Moment Video files and sends the new files to the CVB. Preferably, the CVB is cloud-based. The CVB permanently stores the moment (Inbound Videos Permanent Storage) and sends a moment notification to the user that requested the moment that it is available for viewing. A moment notification may be a text message, an email, an alert from an application, or other form of communication. The form of the moment notification depends, at least in part, upon user preference, the type of venue for the event, and the features loaded to the specific RMS at the venue.

The CVB also processes moments and sends the resulting modified videos to the end-user or an interested third-party according to the system configurations. Moments may be modified in a variety of ways. For example, an event sponsor may request that its logo or advertising be added to a video (Add Logo Module) or a user may wish to have still photographs from a moment (Create Photo Snapshots) or activities coaches may wish to augment a moment for teaching purposes (Modify Video). Each of these modules (Add Logo Module; Create Photo Snapshots; Modify Video) comprise the same functional components.

Specifically, each module includes a queue, e.g. Add Logo Queue, of moment notifications that need to be processed; software programming, e.g., Add Logo Program, that encodes or manipulates the video; and permanent storage for the newly encoded or manipulated videos. Once each video is created, software programming, e.g., Notify Customer Program, notifies an end-user, customer, or interested third-party according to system configurations that their moments or photographs are ready.

Suitable components that may be used in conjunction with the invention include a cloud-based service provider like Amazon Web Services; an SMS service like Twilio—for sending and receiving SMS texts; ffmpeg—for processing video; and RTSP/RTMP—for video streaming.

### Glossary

An “area of interest” is a physical location such as a sports field, arena, park, street intersection, or other physical space at which events or activities occur.

The terms “camera” or “cameras” is used to encompass multiple types of devices. Such devices can be actual cameras or any other devices or sources that output RTSP (Real Time Streaming Protocol) or RTMP (Real-time Messaging Protocol) feeds (i.e. video feeds). Such devices can be mobile or affixed in position. Such devices also must be capable of viewing a physical area of interest and capturing an event or a portion of an event that occurs in the area of interest.

A “Central Video Broker” (CVB) provides cloud-based communication with end-users regarding their capture-moment-requests and communicates with the RMS to obtain moments and distribute moments as well as providing processing to augment moments with logos, stores moments and communicates with end-users to distribute their requested moments.

An “end-user” or “user” is a person who is observing an event and while observing the event submits a request for a video replay of a moment in the event after the moment has occurred.

Herein, an “event” is the totality of an activity being captured by cameras or other devices. Examples include a full sporting match, a parade, a day at a popular street corner or tourist attraction, a full day of golf, a full day of snowboard races or automobile races. These are only examples and are not intended to be all-inclusive.

Herein, the term “loop” is used both as a noun and as a verb. When used as a noun, a loop is a temporary collection of a configurable number of segments. When used as a verb, to loop or looping is the process executed by the RMS to maintain a configured number of segments by overwriting the oldest segment in the collection with the newest segment.

A “moment” is a collection of video segments that are assembled from an event as a result of an end-user's request. A moment is synonymous with a highlight.

A “Replay Management System” (RMS) is a self-contained collection of cameras or other video-capture devices and other equipment that are located at an area of interest and processors that, using various computer programs, perform the action of creating, storing, overwriting and assembling video segments using streams from the cameras or other video-capture devices. The RMS communicates with the CVB to perform the work of assembling moments at the request of an end-user.

Herein the term “segment” is used both as a noun and as a verb. When used as a noun, a segment is a short, configurable-length portion of a running video stream that is saved to a database within the RMS and which is available for later assembly with other contiguous segments of a configured quantity to create one or more video highlights or moments. When used as a verb, segment means to bifurcate an event video stream into short, configurable-length portions.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set. All patents and publications referred to herein are incorporated by reference herein.

What is claimed is:

1. A capture and distribution system having
a) an input video stream from a device that has a view of an area of interest, wherein the device produces a video stream of an event occurring in the area of interest;
b) a replay management system that receives and temporarily stores the video stream in multiple segments; and
c) a central video broker through which a publish-moment-request is sent by a user to the replay management system for a specified moment of the event, whereupon the replay management system captures a specific segment of the video stream and one or more preceding segments of the video stream; combines the specific segment and one or more preceding segments to create a highlight that is sent to the central video broker; and the central video broker sends a moment notification to the user that the specified moment is available for viewing.

2. The capture and distribution system of claim 1, wherein the device is a camera.

3. The capture and distribution system of claim 1, wherein two or more devices have a view of the area of interest.

4. The capture and distribution system of claim 1, wherein the segments are arranged chronologically.

5. The capture and distribution system of claim 1, wherein the replay management system temporarily saves the highlight in a directory monitored by a directory monitor program prior to sending the highlight to the central video broker.

6. The capture and distribution system of claim 1, wherein the central video broker permanently saves the highlight.

7. The capture and distribution system of claim 1, wherein the central video broker adds one or more logos, symbols, statements, or combinations thereof to the highlight and saves the modified highlight prior to sending the moment notification.

8. The capture and distribution system of claim 1, wherein the central video broker creates one or more still pictures from the highlight, permanently saves the still pictures, and sends a pictures notification to the user that the still pictures are available for viewing.

9. The capture and distribution system of claim 1, wherein the central video broker augments the highlight with text, still photos, video, statements, audio, or a combination thereof; permanently saves the augmented highlight; and sends an augmented moment notification to the user that the augmented highlight is available for viewing.

10. The capture and distribution system of claim 1, wherein the highlight comprises three or more segments.

11. The capture and distribution system of claim 1, wherein the highlight comprises 2 second to 15 minutes.

12. A method of creating and distributing a highlight comprising
a) situating at least one device to have a view of an area of interest;
b) producing a video stream of an event occurring in the area of interest with the device;
c) sending the video stream from the device to a replay management system;
d) receiving and temporarily storing the input video stream in multiple chronological segments in the replay management system;
e) sending a publish-moment-request for a specified moment of the event from a user through a central video broker to the replay management system;
f) capturing a specific segment and one or more preceding segments of the temporarily stored video stream, wherein the specific segment and one or more preceding segments encompass the specified moment;
g) combining the specific segment and one or more preceding segments to create a highlight;
h) sending the highlight to the central video broker; and
i) sending a moment notification to the user that the highlight of the requested specified moment is available for viewing.

13. The method of claim 12, wherein the replay management system temporarily saves the highlight in a directory prior to sending the highlight to the central video broker.

14. The method of claim 12, wherein the central video broker permanently saves the highlight.

15. The method of claim 12, wherein at least one device is a camera.

16. The method of claim 12, wherein the central video broker adds one or more logos, symbols, statements, or combinations thereof to the highlight and saves the modified highlight prior to sending the moment notification.

17. The method of claim 12, wherein the central video broker creates one or more still pictures from the highlight, permanently saves the still pictures, and sends a pictures notification to the user that the one or more still pictures are available for viewing.

18. The method of claim 12, wherein the central video broker augments the highlight with text, still photos, video, statements, audio, or a combination thereof; permanently saves the augmented highlight; and sends an augmented highlight notification to the user that the augmented highlight is available for viewing.

19. The method of claim 12, wherein the highlight comprises three or more segments.

20. The method of claim 12, wherein the highlight comprises 2 second to 15 minutes.
